(19) United States
(12) Patent Application Publication
(10) Pub. No.: US 2014/0060272 A1
(43) Pub. Date: Mar. 6, 2014

(54) SYSTEM AND METHOD OF CHILLING A FOOD PRODUCT PROXIMATE TO AND IN A FOOD PROCESSING DEVICE

(71) Applicants: Paul Cyrus Shah, Palatine, IL (US); Gary Dee Lang, Naperville, IL (US); Bruce Michael Squires, Naperville, IL (US); Theodore Hall Gasteyer, III, Naperville, IL (US); Balazs Hunek, Chicago, IL (US); Steven Michael McCarty, Glendale Heights, IL (US)

(72) Inventors: Paul Cyrus Shah, Palatine, IL (US); Gary Dee Lang, Naperville, IL (US); Bruce Michael Squires, Naperville, IL (US); Theodore Hall Gasteyer, III, Naperville, IL (US); Balazs Hunek, Chicago, IL (US); Steven Michael McCarty, Glendale Heights, IL (US)

(21) Appl. No.: 14/072,598

(22) Filed: Nov. 5, 2013

Related U.S. Application Data
(63) Continuation of application No. 12/963,911, filed on Dec. 9, 2010.
(60) Provisional application No. 61/285,677, filed on Dec. 11, 2009.

(51) Int. Cl. A23L 3/36; A23L 3/375

(52) U.S. Cl. CPC A23L 3/362; A23L 3/375
USPC 83/15; 83/170; 62/63

(57) ABSTRACT

A system and method for chilling a food product in or proximate to a food processing device adapted to dice, slice, shred, chop, or cut the food product is disclosed. The disclosed system and method involves a two or three stage application of a liquid cryogen or carbon dioxide snow to cool the food product. The cooling stages include a first stage of cryogen application upstream of the entrance of the food processing device, a second stage of cryogen application or delivery into one or more zones within the food processing device, and a third stage of cryogen application to the region proximate to and downstream of the exit to the food processing device.

### CROSS REFERENCE TO RELATED APPLICATIONS

This patent application claims priority to U.S. provisional patent application Ser. No. 61/285,677 filed Dec. 11, 2009, the disclosure of which is incorporated by reference herein.

### FIELD OF THE INVENTION

The present invention relates to a method and apparatus for reducing the temperature of a food product on a conveyor within a confined footprint of food processing equipment, and more particularly on a conveyor associated with a food product slicer or dicer.

### BACKGROUND

In the food processing industry, food products are often subjected to a series of individual steps or processes including preparation, cooking, portioning, freezing, packaging, etc. At each step in the process, it is desirable that the food product being processed is maintained at a specified temperature, often driven by food safety practices and regulations.

In some processes for processing food, particularly for processing meat, the product may be at ambient temperature or higher such as in cases where the meat has been subjected to a processing step involving cooking or partially cooking the meat. Meat that is hot-diced after being conveyed a short distance from the oven/cooker to the dicer is relatively hot and tends to lose a significant quantity of moisture due to evaporation of moisture from the much increased surface area opened up during dicing. Anywhere from 8% to 12% of the weight of the hot, cooked meat can be lost as a result of moisture loss during the dicing or slicing process. After the dicing process, the food product is typically conveyed or transported further downstream to a mechanical or cryogenic freezer to chill or freeze the diced product and preserve any residual moisture remaining in the food product.

Various related art solutions, including the cold meat dicing process, have attempted to chill the food product in a tunnel type chilling unit upon exit from the oven and prior to being conveyed or sent to the dicer. However, these pre-chilling solutions typically involve higher capital costs and require a larger footprint and extra conveyors due to the presence of the pre-chiller tunnel unit. In addition, such pre-chill solutions still have a moisture loss of about 5% to 7% of the weight of the cooked meat.

Other related art devices have contemplated use of cryogen gases injected directly in the dicer. However, the cryogens gases used mainly to improve the appearance and shelf life of the food product by replacing oxygen present in the dicer atmosphere with carbon dioxide or nitrogen gas.

While these related technical solutions have been disclosed in the prior art, they have yet to achieve an optimum combination of a rapid heat extraction and temperature reduction in a relatively small space or footprint associated with food processing equipment that operates at a rapid rate of throughput such as dicers, slicers, shredders, etc. More importantly, the related art systems and methods have not achieved the economic benefits companies are seeking in the form of less yield losses due to moisture evaporation during the dicing or slicing type processes. The present system and method described herein achieves these advantages together with other performance and design advantages as disclosed herein.

### SUMMARY OF THE INVENTION

The present invention may be characterized as a method for hot dicing a food product in a dicer comprising the steps of: (i) applying cryogen or carbon dioxide snow to an upstream conveyor prior to the food product being placed on the upstream conveyor, the upstream conveyor disposed upstream of the dicer and adapted to transport the food product into the dicer; (ii) applying additional cryogen or carbon dioxide snow directly to the food product disposed on the upstream conveyor; (iii) dicing the food product within the dicer; and (iv) applying yet additional cryogen or carbon dioxide snow to the diced food product after exiting the dicer.

The invention may also be characterized as a system comprising: a food dicer having an entrance, an exit and a conveyor to transport a food product into and through the dicer, the dicer further including cutting blades or knives adapted to slice or dice the food product; a source of liquid cryogen or carbon dioxide and a plurality of cryogen or carbon dioxide snow delivery devices for applying the cryogen or carbon dioxide snow while the food product is conveyed upstream, through and downstream of the dicer. More specifically, the system includes: one or more first cryogen or carbon dioxide snow delivery devices disposed upstream of the entrance of the dicer and coupled to the source of liquid cryogen or carbon dioxide for applying the cryogen or carbon dioxide snow to the conveyor at a location where the food product is placed on the conveyor; one or more second cryogen or carbon dioxide snow delivery devices disposed proximate to upstream of the entrance of the dicer and coupled to the source of liquid cryogen or carbon dioxide for applying the cryogen or carbon dioxide snow to the food product on the conveyor at a location downstream of where the food product is placed on the conveyor; and one or more third cryogen or carbon dioxide snow delivery devices disposed proximate to downstream of the exit from the food dicer and coupled to the source of liquid cryogen or carbon dioxide for applying the cryogen or carbon dioxide snow to the diced food product upon exiting the dicer.

Finally, the invention may also be characterized as a method for chilling a food product in and proximate to a food processing device adapted to dice, slice, shred, chop, or cut the food product. The method comprises the steps of: (i) injecting or delivering cryogen or carbon dioxide snow to the region proximate to and upstream of an entrance to the food processing device: (ii) injecting or delivering cryogen or carbon dioxide snow in one or more zones within the food processing device; and (iii) injecting or delivering cryogen or carbon dioxide snow to the region proximate to and downstream of an exit of the food processing device.

### BRIEF DESCRIPTION OF THE DRAWINGS

The above and other aspects, features, and advantages of the present invention will be more apparent from the following, more detailed description thereof, presented in conjunction with the following drawings, wherein:

FIG. 1 is a conceptual illustration of the system and process for hot-meat dicing a food product using in-situ chilling of the conveyed food product with cryogen or carbon dioxide snow proximate the dicer;

FIG. 2 is a schematic illustration of an embodiment of a system for in-situ chilling a food product with cryogen or carbon dioxide snow proximate a food processing device adapted to dice, slice, shred, chop, or cut the food product;

FIG. 3 is a perspective view of an embodiment of the system and method for hot-meat dicing a conveyed food product in accordance with the present invention:

FIG. 4 is a top cut-away view of the system of FIG. 3;

FIG. 5 is a side cut-away view of the system of FIG. 3 showing the arrangement of the conveyors, injectors, and exhaust subsystem;

FIG. 6 is a side cut-away view of an alternate embodiment of the system and method for hot-meat dicing in accordance with the present invention; and

FIG. 7 is an illustration of a plurality of J Tube snow horns used in some of the described embodiments to deliver carbon dioxide snow in accordance with the present invention.

In the drawings, the same reference numbers are used to describe the same or similar components in the various illustrated embodiments.

### DESCRIPTION

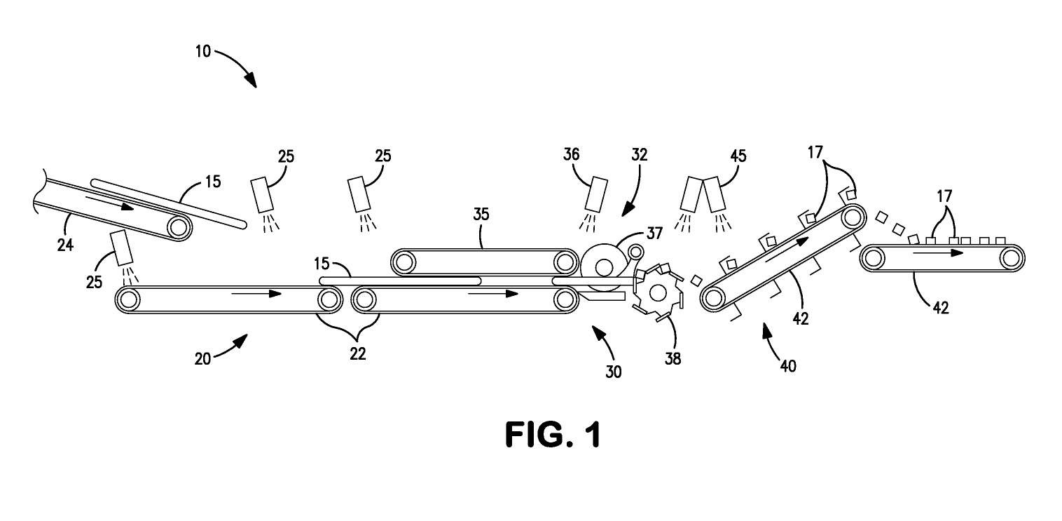

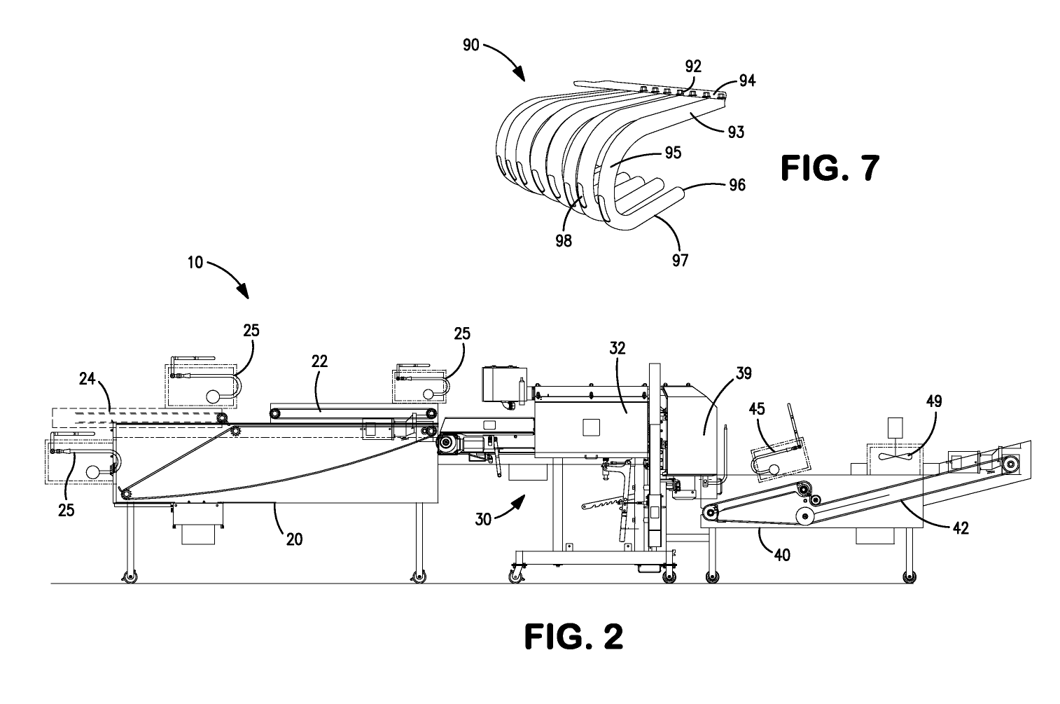

FIG. 1 is a conceptual illustration of the system and process for hot-meat dicing a food product using in-situ chilling of the food product with liquid cryogen or carbon dioxide snow proximate the dicer. Similarly, FIG. 2 is a more detailed illustration of a system for in-situ chilling a food product proximate a food processing device adapted to dice, slice, shred, chop, or cut the food product.

The illustrated systems of FIG. 1 and FIG. 2 are directed to cooling meat, poultry or other food product that are coming out of an oven/cooker and that require a dicing or slicing process before entering the final freezer or chiller. In general, the present systems 10 and methods extract the heat from the meat or poultry in a small footprint or confined zone thereby minimizing product losses and improving the economics of the overall food processing.

Specifically, the illustrated embodiments contemplate heat extraction from the food product in two or three distinct stages. The first stage 20 of heat extraction is at a location immediately upstream of the food processing equipment 32, preferably a dicer. The second stage 30 of heat extraction optionally occurs at a plurality of locations or zones within the food dicer 32 and the third stage 40 of heat extraction occurs at a location immediately downstream of the food dicer 32. Although the embodiments described herein are tailored to meat dicers from two separate manufacturers, namely Urschel Laboratories, Inc. and Carruthers Equipment Company, it should be understood that the present invention can be applied to other dicers, slicers, shredders, choppers and even in conjunction with other forms of food processing equipment 32 that employ a relatively small footprint.

The target amount of heat to be removed with the present system is very much dependent upon the food product being processed and the targeted product temperature. For hot chicken meat that is to be diced, the heat removal that can be achieved within the presently disclosed systems is from about 60 Btu/lb to about 90 Btu/lb of meat in the confined footprint of the present embodiments. The targeted dwell time or minimum residence time the food product is exposed to the liquid cryogen or carbon dioxide snow in the preferred embodiments is between about 30 seconds to 45 seconds which translates to an average heat removal rate of about 1.25 to 3.0 Btu/lb of heat removal per second of residency time.

In the first stage 20 of chilling, the hot food product 15 exiting the oven/cooker (not shown) is subjected to carbon dioxide snow (or other liquid or solid cryogen) during transport between the oven/cooker and the dicer 32. The food product is preferably transferred from a transfer conveyor 24 exiting the oven/cooker to a primary conveyor 22 transporting the food product through the dicer 32. The locations of the cryogen injectors 25 are preferably oriented to apply the cryogen directly to the primary conveyor belt 22 and directly to the food product 15 on the conveyor belt 22. The carbon dioxide snow applied directly to the primary conveyor 22 cools the underside of food product 15 as the food product 15 is transferred from the transfer conveyor 24 to the primary conveyor 22. The dry ice snow applied directly to the food product 15 cools the exposed top surfaces of the food product 15. In fact, excess snow is preferably applied to the top surface of the food product 15 such that the heat removal continues as the food product 15 is conveyed into the dicer 32. The excess snow on the top surface of the food product 15 is also preferably pressed into the food product 15 by a press belt 35 disposed outside the dicer and/or a similar feed roller 35 disposed within the dicer 32.

Within the dicer 32, carbon dioxide snow is optionally injected in three regions or zones including: (i) proximate to and upstream of the top belt or feed roller 35; (ii) between the feed roller 35 and the circular knives 37; and (iii) the exit chute 39 downstream of the circular knives 37.

In the first cooling region within the food dicer 32, namely proximate the feed roller 35, the carbon dioxide snow is generated with one or more rows of SilentSnow™ tubes or J-Tube snow horns supplied by Praxair, Inc. or similar devices to create an even and continuous blanket of carbon dioxide snow over the incoming food product 15. At the second region within the food dicer 32, or the region between the feed roller 35 and the circular knives 37, finer ribbons of carbon dioxide snow are applied using one or more rows of the smaller diameter tube SilentSnow™ cylinders or tubes or the J-Tube snow horns. At the third cooling region within the food dicer 32, namely the exit chute 39 downstream of the circular knives 37, one or more rows of nozzles are utilized to impinge the carbon dioxide snow onto the diced food product 17. Direct impingement of carbon dioxide snow in this third area within the dicer 32 is configured to produce larger quantities of carbon dioxide snow to allow the food product to exit via the exit chute 39 of the dicer 32 covered with carbon dioxide snow.

Descriptions and examples of SilentSnow™ cylinders or tubes are described in U.S. Pat. Nos. 6,151,913 and 6,543,251 the disclosures of which are incorporated by reference herein. Alternatives to the SilentSnow™ cylinders or tubes include the Pressure Responsive Automatic Shut Off (PRASO) valve injection system supplied by Praxair, Inc. or the J-Tube snow horns all of which are supplied by Praxair, Inc., or other suitable cryogen delivery nozzles.

The dicer 32 can be configured with or without provisions for cross-cutting the food product. For dicers outfitted with cross cutting features, the cross cutters 38 are disposed either upstream or downstream of the circular knives. It may also be beneficial to apply the cryogen or carbon dioxide snow directly to the circular knives 37 and/or cross cutters 38 which would further cool the food product as it is being diced or sliced.

Additional modifications to the dicers may also be required such as design changes to the equipment housing and covers to allow the liquid cryogen or carbon dioxide tubing to supply the liquid cryogen or carbon dioxide into the equipment. For simplicity and sake of clarity, the equipment covers are not shown in the Figures. The conveyor belts within the dicer may also be modified to use solid stainless steel belts or other belt materials and configurations to enhance the heat removal aspect of the present system and otherwise to prevent sticking of the chilled food product to the dicer belts. Also to prevent sticking of the chilled food product to the blades or cross-cutters, it may be advantageous in some applications to warm the blades with the spent or warm gas.

The diced food product 17 along with carbon dioxide snow will exit the food dicer 32 via the exit chute 39 and immediately be subjected to the third stage 40 of heat extraction where carbon dioxide snow (or other liquid cryogen) is applied using suitable injectors 45 directly to the diced food product 17 on a downstream conveyor 42. In addition, various fans 49 are employed in the third stage 40 of heat extraction to circulate any cryogen vapors proximate the diced food product 17 on the downstream conveyor 42 to further cool the diced food product 17 to the desired or target temperature. Use of a fan 49 above the downstream conveyor 42 increases convection between the diced food product 17 and the carbon dioxide snow to provide additional heat removal and aids in sublimating the last of the carbon dioxide snow before the diced food product 17 enters the mechanical freezer or chiller (not shown).

It is advantageous to allow the diced food product 17 to maintain a sufficient dwell time in this third stage 40. Examples of equipment or conveyors that can be employed in this third stage 40 downstream of the food dicer 32 include a cleated belt conveyor, a rotary table, a flighted belt conveyor, a bucket conveyor or similar conveyor equipment having a small footprint. The use of flighted or drop conveyor to mix up the diced food product 17 is preferred in order to expose more surfaces of the diced food product 17 to the applied snow.

In the third stage 40 of the present system and method, it may be advantageous to optionally apply carbon dioxide snow directly to the belt of the downstream conveyor 42 to provide a bed of snow for the diced food product 17 exiting the dicer 32 to immediately cool the freshly cut meat. In addition, the present system and method continuously or intermittently applies carbon dioxide snow to the diced food product 17 disposed on the downstream conveyor 42. It may also be helpful to vibrate the downstream conveyor 42 to allow the applied snow to filter down through the diced food product 42 to increase the contact between the snow and the diced food product 17. In some embodiments, it may also be preferable to use a slower belt speed on the downstream conveyor 42 to allow the diced food product 17 to stack-up on the downstream conveyor 42 thus providing a longer residency time in this stage and more contact time between the snow and the diced food product 17.

Either liquid nitrogen or carbon dioxide snow can be used as the source of cooling in the present system and method. Carbon dioxide snow is preferred since more cooling capacity per pound is available. Use of liquid nitrogen, if not applied properly, can have an adverse impact on the performance of the food dicer. Also, it should be noted that if liquid nitrogen is utilized in any or all of the chilling stages, the application method may be different although the cooling will be performed in the same areas. Additional exhausting and other safety features may also be required to ensure a safe environment for operators.

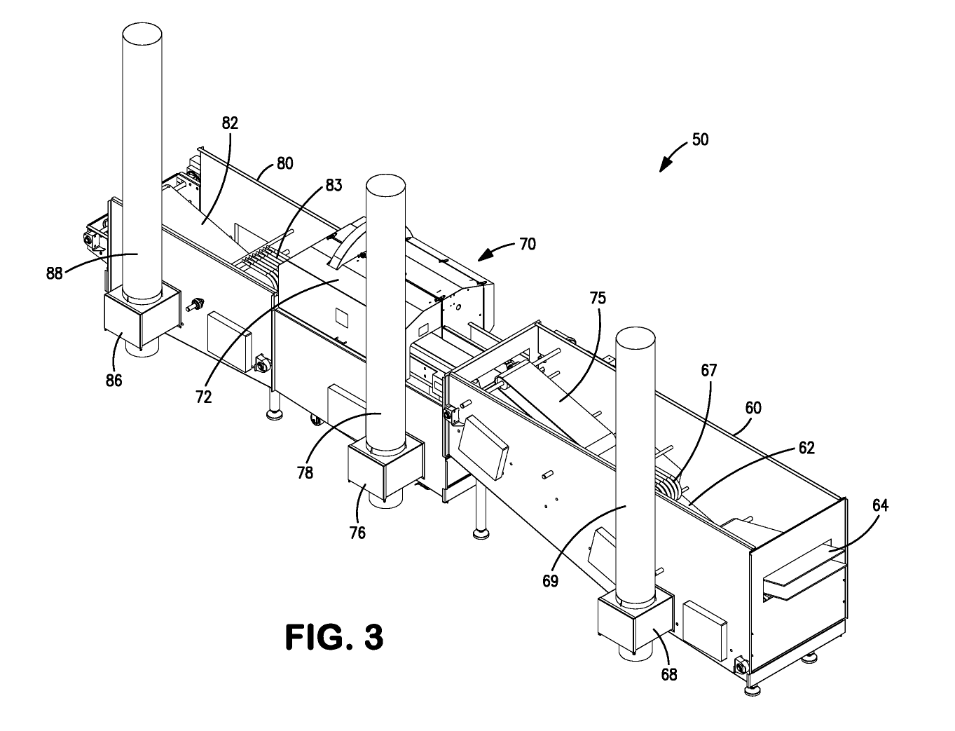

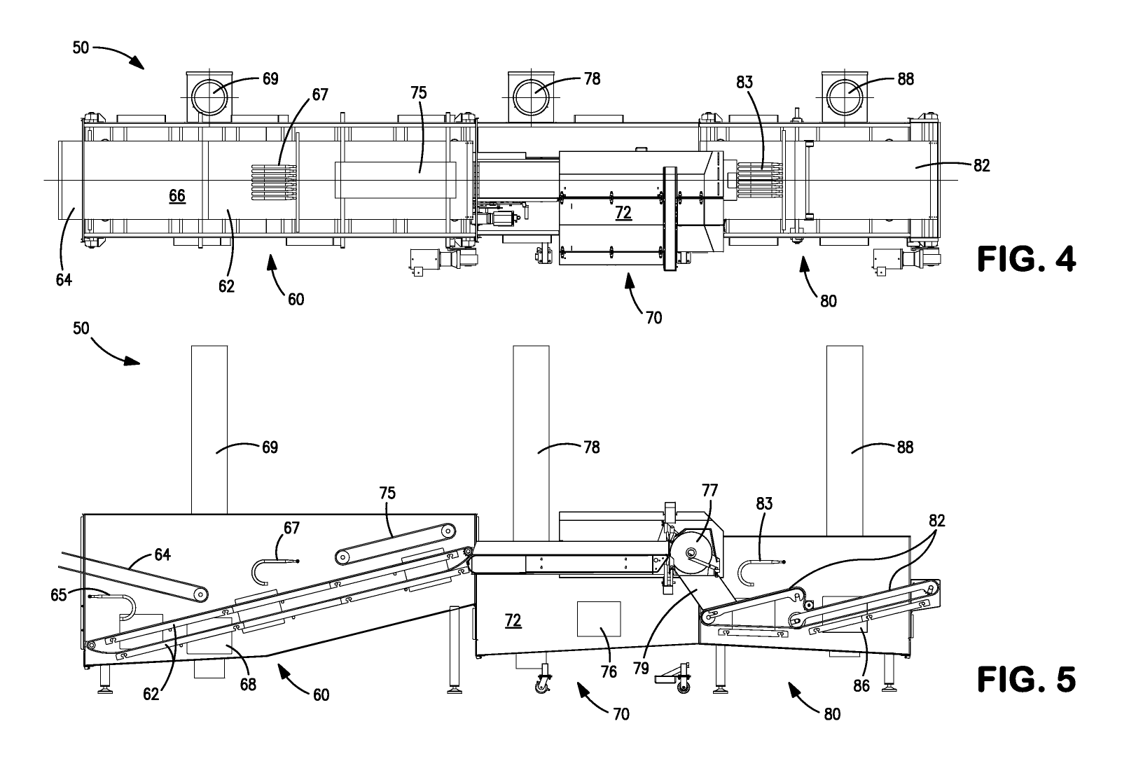

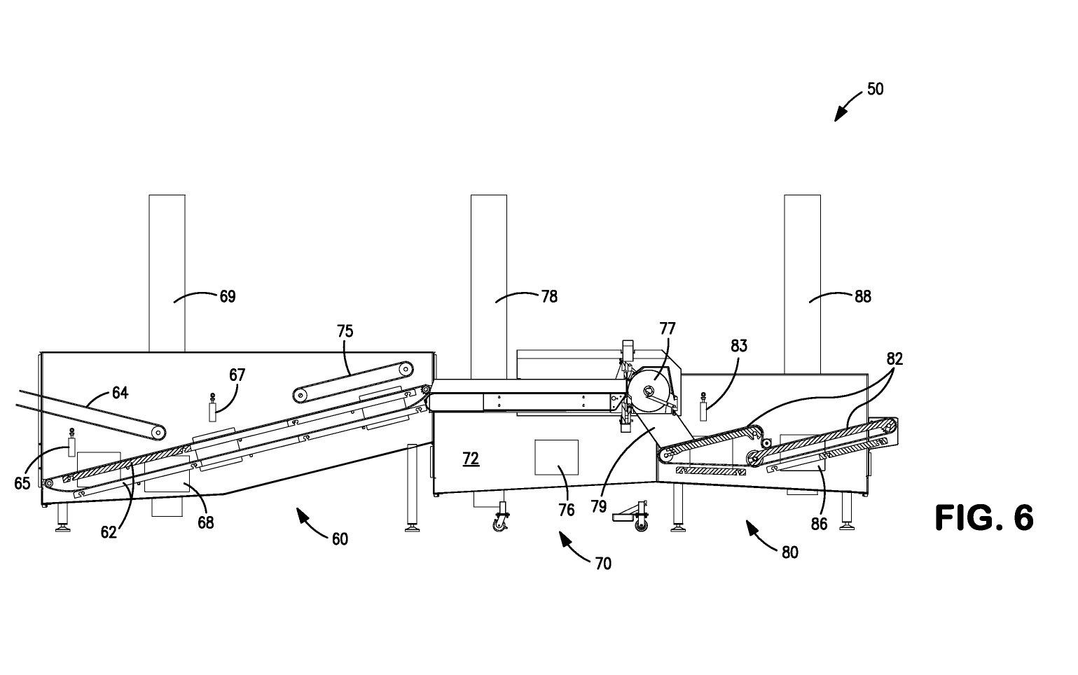

Turning now to FIGS. 3 through 6, there are shown preferred embodiments of the present system and method for hot-meat dicing a food product. The present hot-meat dicing system 50 includes an upstream conveyor section 60; a food processing section 70 that includes the food processing device such as a dicer 72, and a downstream chilling station 80 disposed immediately downstream of the dicer 72.

The upstream conveyor section 60 is preferably a 9 foot long structure that includes a primary conveyor 62, a transfer conveyor 64, and a first set of cryogen injectors 65 positioned to deliver cryogen, preferably carbon dioxide snow, to the belt 66 of primary conveyor 62 before any food product is transferred to the primary conveyor 62. The upstream section 60 further includes a second set of cryogen injectors 67 disposed downstream of the transfer conveyor 64 and arranged to deliver cryogen, preferably carbon dioxide snow, to the surface of the food product that is transferred from the transfer conveyor 64 to the primary conveyor 62. An exhaust pick-up 68 and exhaust conduit 69 are also included as part of the upstream conveyor section 60

The food processing section 70 includes a commercially available dicer 72 of the type manufactured from Urschel Laboratories, Inc. or Carruthers Equipment Company or other food processing device. The dicer 72 is optionally equipped with at least one set of cryogen injectors 73 for delivering cryogen, preferably carbon dioxide snow, to the food product transported on the conveyor 74 within the dicer 72. Many dicers are also equipped with a top press belt or feed roller 75 that forces the food product to the circular knives 77 within the dicer 72 and may be further adapted to also press any carbon dioxide snow on the top surface of the food product into the food product to enhance the heat removal from the food product. The dicer 72 is further retrofitted to be equipped with exhaust pick-up 76 and exhaust conduit 78.

The downstream chilling station 80 is preferably a 9 foot long structure that includes a small conveyor, preferably a flighted conveyor 82 for receiving the semi-chilled diced food product exiting the chute 79 of the dicer 72. The dropping action of the flighted conveyor 82 provides good mixing of the diced food product and exposes different surfaces of the diced food product to the liquid cryogen or carbon dioxide snow resulting in higher heat removal over the prescribed dwell time. Alternatively, a small rotary table could be used in lieu of a flighted conveyor 82. The downstream chilling station 80 is also equipped with at least one set of injectors 83 for delivering cryogen or carbon dioxide snow to the diced food product exiting the dicer and transported on the flighted conveyor 82. As with the other sections of the present system 50, the downstream chilling station 80 also includes an exhaust pick-up 86 and exhaust conduit 88 for rapidly removing the spent vapors from the process area.

In the disclosed hot-meat dicing embodiments, it is important to retain a small footprint for the system, as food processors that have ample space and resources would employ the traditional cold-meat dicing arrangement. To keep the hot-meat dicing system footprint as small as possible while achieving the desired heat removal in a safe environment, the present system and method employs a localized exhaust scheme. In other words, each section of the present system, namely the upstream conveyor, the dicer, and the downstream chilling station, each have a separate carbon dioxide vapor pick-up and exhaust conduit. Using the separate carbon dioxide vapor pick-ups and exhaust conduits, the surrounding atmosphere at all stations remains safe to operators. The exhaust gases carried away from the present system can be vented to the outside atmosphere, recycled, or re-used elsewhere in the plant.

All of the above-described embodiments utilize a plurality of cryogen injectors disposed at prescribed locations along the upstream conveyor, the dicer, and the downstream conveyor. The injectors are sized to apply uniform coverage of the food product with cryogen or carbon dioxide snow. In the case of using liquid cryogens, the injectors can be adapted to deliver either a spray or a raining sheet of liquid cryogen to the food product, the top surface of the conveyor belt or even the underside of the conveyor belt. In the case of using carbon dioxide snow, the injectors are preferably SilentSnow™ devices as generally shown and described in in U.S. Pat. Nos. 6,151,913 and 6,543,251 or a J-Tube snow horns, described in more detail below, which are appropriately sized to deliver a non-clumping, uniform coverage of snow having the prescribed particle size distribution and exit velocity to the prescribed locations.

The J-Tube type snow horns depicted in FIG. 7 is a tube or plurality of tubes having a round or a rectangular cross-section, preferably a round cross-section. The proximate end of the tube is connected to a carbon dioxide manifold or supply conduit whereas the distal end of the tube is open to the ambient atmosphere and preferably oriented or disposed near an exhaust intake of the present system. A disc with a plurality of apertures or holes is disposed in the proximate end of the tube and in fluid communication with the liquid carbon dioxide in the supply conduit or manifold. As the liquid carbon dioxide moves from the supply conduit through the apertures into the tube, the carbon dioxide expands into a mixture of solid carbon dioxide (i.e. carbon dioxide snow) and carbon dioxide gas. The mixture of carbon dioxide snow and gas moves through the length of the tube and is delivered to prescribed locations in the present system.

The J-Tube snow horns also include a first straight portion, a curved portion, and a second straight portion forming a configuration of each tube in appearance similar to the letter ‘J’. The curved portion of each tube includes a slot or opening on the outer radius of the curved portion allowing carbon dioxide snow to exit therethrough while most of the carbon dioxide gas continues through the curved portion of the tube and the second straight portion of the tube to the distal end. As a result, the carbon dioxide snow is deposited at the prescribed locations in the present system and proximate the slot or opening of each tube. The carbon dioxide gas is further carried by the J-Tube to the distal end which is located proximate the exhaust pick-ups. Separating the carbon dioxide snow from the carbon dioxide vapor prevents the vapor from pushing or moving the carbon dioxide snow out of the desired location.

### Examples

Several test runs of a prototype hot-meat dicing system that included an upstream conveyor, a commercially available dicer modified in accordance with the above-described invention, and a downstream chilling station that included a flighted conveyor. The food product tested was a sheet of chicken meat approximately 0.5 inches thick. A total of seven injection points were evaluated using the J-Tube type snow horns adapted to deliver carbon dioxide from a header at a prescribed pressure, as set forth in Table 1, below. The belt speed of the upstream conveyor was about 20 feet per minute while the belt speed in the dicer was about 17 feet per minute and the belt speed of the downstream conveyor was only 10 feet per second. The knife speed within the dicer was operated at about 74 revolutions per minute.

The arrangement of the seven carbon dioxide injection points within the prototype hot-meat dicing system includes: (i) an upstream injection point adapted to deliver carbon dioxide snow to the surface of the upstream conveyor belt, (ii) an upstream injection point adapted to deliver carbon dioxide snow to the top surface of the sheet of chicken meat while on the upstream conveyor; (iii) an injection point within or near the dicer and upstream of the feed roller or press belt adapted to deliver carbon dioxide snow to the meat; (iv) an injection point within or near the dicer and downstream of the cutting knives adapted to deliver carbon dioxide snow to the diced meat; (v) an injection point as part of the downstream chilling station adapted to deliver carbon dioxide snow to the surface of the downstream conveyor belt; (vi) an injection point as part of the downstream chilling station adapted to deliver carbon dioxide snow to the diced meat as it exits the dicer; and (vii) an injection point as part of the downstream chilling station adapted to deliver carbon dioxide snow to the diced meat as it drops along the flighted conveyor.

The results of the 9 test runs are set forth in Table 1. As seen therein, with no in-line or in-situ cooling of the hot-meat dicing system, the heat removal from the sheet of chicken meat was estimated to be about 28 Btu/lb. However, with upstream cooling of the meat, the heat removal observed was between about 75 BTU/lb and 80 Btu/lb with an average of about 78 Btu/lb. Adding the dicer cooling to the upstream cooling, the observed heat removal averaged about 86 Btu/lb or about 10% additional heat removal compared to upstream cooling only. Finally, adding the downstream chilling to the process resulted in an average heat removal of about 90 Btu/lb±2.4 Btu/lb variance.

From these results, the overall heat extraction of up to about 90 Btu/lb is possible which would make this in-line or in-situ cooling of a hot-meat dice process comparable to high capital cold-meat dice solutions with a moisture loss of about 7% of the weight of the cooked meat. Also, in comparison to the existing hot-meat dice applications, where a 10% evaporative loss is commonplace, the present system and method with evaporative loss limited to about 7% represents a significant process improvement and economically attractive solution.

TABLE 1

| SYSTEM | | | HEAT | AVG HEAT | |
|---|---|---|---|---|---|
| CONFIG | CARBON DIOXIDE DELIVERY | TEST# | REMOVAL | REMOVAL | |
| No Chilling | No Carbon Dioxide Snow Applied | | | ~28 | Btu/lb |
| Upstream | Upstream Belt Snow with 8 J-Tubes @250 psi | Test 1 | 79.7 Btu/lb | 78 | Btu/lb |
| Conveyor | Upstream Top Snow with 8 J-Tubes @250 psi | Test 2 | 75.0 Btu/lb | | |
| | | Test 3 | 78.9 Btu/lb | | |
| Upstream | Upstream Belt Snow with 8 J-Tubes @250 psi | Test 4 | 87.5 Btu/lb | 86 | Btu/lb |
| Conveyor & | Upstream Top Snow with 8 J-Tubes @250 psi + | Test 5 | 85.9 Btu/lb | | |
| Dicer | Dicer Top Snow-Zone 1 with 5 J-Tubes @250 psi | | | | |
| | Dicer Snow - Zone 2 with 8 J-Tubes @250 psi | | | | |
| Upstream | Upstream Belt Snow with 8 J-Tubes @230 psi | Test 6 | 87.6 Btu/lb | 90 | Btu/lb |
| Conveyor & | Upstream Top Snow with 8 J-Tubes @230 psi + | Test 7 | 89.6 Btu/lb | | |
| Dicer & | Dicer Top Snow-Zone 1 with 5 J-Tubes @230 psi | Test 8 | 89.6 Btu/lb | | |
| Downstream | Dicer Snow - Zone 2 with 8 J-Tubes @230 psi + | Test 9 | 92.4 Btu/lb | | |
| Chilling | Downstream Belt Snow with 8 J-Tubes @230 psi | | | | |
| | Downstream Chute Snow with 8 J-Tubes @230 psi | | | | |
| | Downstream Snow -FlightDrop 5 J-Tubes @230 psi | | | | |

From the foregoing, it should be appreciated that the present invention thus provides a system and method of in-line or in-situ chilling a food product in a small footprint food processing device adapted to dice, slice, shred, chop, or cut the food product. Various modifications, changes, and variations of the present method and system will be apparent to a person skilled in the art. For example, the means for delivering the liquid cryogen or carbon dioxide snow may be alternate types of devices or systems tailored specifically to the food processing equipment employing the chilling technique. Likewise, variations of the downstream product handling systems and conveyor systems including circular conveyors with or without flights to further minimize the system footprint are possible. It is to be understood that any such alternate configurations, modifications, changes, and variations are to be included within the purview of this application and the spirit and scope of the claims.

What is claimed is:

1. A method for hot dicing a food product in a dicer comprising the steps of:
applying cryogen or carbon dioxide snow to an upstream conveyor just before the food product is placed on the upstream conveyor, the upstream conveyor disposed upstream of the dicer and adapted to transport the food product into the dicer;
applying additional cryogen or carbon dioxide snow directly to the food product disposed on the upstream conveyor,
dicing the food product within the dicer; and
applying yet additional cryogen or carbon dioxide snow to the diced food product after exiting the dicer.

2. The method of claim 1 further comprising the step of applying cryogen or carbon dioxide snow within the dicer to cool the food product in the dicer.

3. The method of claim 2 wherein the dicer includes one or more sets of cutting knives and further comprising the step of applying cryogen or carbon dioxide snow proximate the cutting knives to cool the food product as it is being diced.

4. The method of claim 2 wherein the dicer includes an exit chute and wherein the step of applying cryogen or carbon dioxide snow further comprises applying cryogen or carbon dioxide snow to the diced food product in or proximate to the exit chute.

5. The method of claim 2 wherein the dicer includes a press belt and further comprising the step of applying cryogen or carbon dioxide snow to the food product as the food product enters the press belt.

6. The method of claim 1 wherein the step of applying cryogen or carbon dioxide snow directly to the food product further comprises applying excess carbon dioxide snow to the food product and said excess carbon dioxide snow is carried into the dicer.

7. The method of claim 1 wherein the diced food product is placed on a flighted conveyor belt upon exiting the dicer and the step of applying cryogen or carbon dioxide snow to the diced food product upon exiting the dicer further comprises applying cryogen or carbon dioxide snow to the diced food product as the food product drops on the flighted conveyor.

8. The method of claim 1 wherein the step of applying cryogen or carbon dioxide snow to the diced food product upon exiting the dicer further comprises concurrently applying cryogen or carbon dioxide snow to the diced food product while mixing or vibrating the diced food product.

9. The method of claim 1 wherein the food product is meat and the heat removal from the meat during the hot dicing process is between about 60 Btu per pound of meat and about 90 Btu per pound of meat.

10. A system for hot dicing a food product in a dicer comprising:
a food dicer having an entrance, an exit and a conveyor to transport a food product into and through the dicer, the dicer further including cutting blades or knives adapted to slice or dice the food product;
a source of liquid cryogen or carbon dioxide;
one or more first cryogen or carbon dioxide snow delivery devices disposed upstream of the entrance of the dicer and coupled to the source of liquid cryogen or carbon dioxide for applying the cryogen or carbon dioxide snow to the conveyor at a location where the food product is placed on the conveyor,
one or more second cryogen or carbon dioxide snow delivery devices disposed proximate to upstream of the entrance of the dicer and coupled to the source of liquid cryogen or carbon dioxide for applying the cryogen or carbon dioxide snow to the food product on the conveyor at a location downstream of where the food product is placed on the conveyor; and
one or more third cryogen or carbon dioxide snow delivery devices disposed proximate to downstream of the exit from the food dicer and coupled to the source of liquid cryogen or carbon dioxide for applying the cryogen or carbon dioxide snow to the diced food product upon exiting the dicer.

11. The system of claim 10 further comprising one or more fourth cryogen or carbon dioxide snow delivery devices disposed within the dicer and coupled to the source of liquid cryogen or carbon dioxide for applying the cryogen or carbon dioxide snow to the food product while the food product is within the dicer.

12. The system of claim 11 further comprising a press belt disposed within the dicer or upstream of the dicer and cryogen or carbon dioxide snow delivery devices are oriented to apply carbon dioxide snow to the food product as the food product enters the press belt.

13. The system of claim 10 further comprising a flighted conveyor disposed proximate to downstream of the exit from the food dicer wherein the diced food product is placed on the flighted conveyor belt upon exiting the dicer and the third cryogen or carbon dioxide snow delivery devices are oriented to apply the cryogen or carbon dioxide snow to the diced food product as the food product drops on the flighted conveyor.

14. The system of claim 10 wherein the food product is meat and the heat removal from the meat during the hot-dicing is between about 60 Btu per pound of meat and about 90 Btu per pound of meat.

15. A method for chilling a food product in and proximate to a food processing device adapted to dice, slice, shred, chop, or cut the food product, the method comprising the steps of:
injecting or delivering cryogen or carbon dioxide snow to the region proximate to and upstream of an entrance to the food processing device;
injecting or delivering cryogen or carbon dioxide snow in one or more zones within the food processing device; and
injecting or delivering cryogen or carbon dioxide snow to the region proximate to and downstream of an exit of the food processing device.
